(19) United States
(12) Patent Application Publication
(10) Pub. No.: US 2016/0365002 A1
(43) Pub. Date: Dec. 15, 2016

(54) EDUCATIONAL CUP SYSTEM

(71) Applicants: Xiong Gong Yuan, China (CN); Luo Xiao Lan, China (CN); Allen J. Raymond, Trinity, FL (US)

(72) Inventors: Xiong Gong Yuan, China (CN); Luo Xiao Lan, China (CN); Allen J. Raymond, Trinity, FL (US)

(21) Appl. No.: 14/736,628

(22) Filed: Jun. 11, 2015

(51) Int. Cl. G09B 19/00

(52) U.S. Cl. CPC G09B 19/0084; G09B 19/0007

(57) ABSTRACT

A cup has an open cup top, a closed cup bottom, and a cup side wall. A base has a closed base top, a closed base bottom, and a base side wall. A coupling assembly includes a lower coupling plate in the closed base top. The coupling assembly includes an upper coupling plate in the closed cup bottom. The L-shaped projections in the upper coupling plate are adapted to be inserted into apertures in the lower coupling plate for coupling the cup and the base. A sound assembly includes a lowermost sound plate in the closed base bottom. A musical chip is mounted to the lowermost sound plate. A button extending through the base side wall is operatively coupled to the musical chip.

### BACKGROUND OF THE INVENTION

### Field of the Invention

The present invention relates to an educational cup system and more particularly pertains to playing a song for a programmable time corresponding a preferred time for a child to brush his/her teeth, the playing of the song and the programming of the preferred time being done in a safe, simple, convenient, and economical manner.

### Description of the Prior Art

The use of tooth brushing timing devices of known designs and configurations is known in the prior art. More specifically, tooth brushing timing devices of known designs and configurations previously devised and utilized for the purpose of providing a mechanism for timing tooth brushing are known to consist basically of familiar, expected, and obvious structural configurations, notwithstanding the myriad of designs encompassed by the crowded prior art which has been developed for the fulfillment of countless objectives and requirements.

While these devices fulfill their respective, particular objectives and requirements, they do not describe an educational cup system that allows playing a song for a programmable time corresponding to a preferred time for a child to brush his/her teeth, the playing of the song and the programming of the preferred time being done in a safe, simple, convenient, and economical manner.

In this respect, the educational cup system according to the present invention substantially departs from the conventional concepts and designs of the prior art, and in doing so provides an apparatus primarily developed for the purpose of playing a song for a programmable time corresponding to a preferred time for a child to brush his/her teeth, the playing of the song and the programming of the preferred time being done in a safe, simple, convenient, and economical manner.

Therefore, it can be appreciated that there exists a continuing need for a new and improved educational cup system which can be used for playing a song for a programmable time corresponding to a preferred time for a child to brush his/her teeth, the playing of the song and the programming of the preferred time being done in a safe, simple, convenient, and economical manner. In this regard, the present invention substantially fulfills this need.

### SUMMARY OF THE INVENTION

In view of the disadvantages inherent in the known types of musical systems of known designs and configurations now present in the prior art, the present invention provides an improved educational cup system. As such, the general purpose of the present invention, which will be described subsequently in greater detail, is to play a song for a programmable time corresponding a preferred time for a child to brush his/her teeth, the playing of the song and the programming of the preferred time being done in a safe, simple, convenient, and economical manner.

From a broad viewpoint, the present invention is an educational cup system. A cup has an open cup top, a closed cup bottom, and a cup side wall. A base has a closed base top, a closed base bottom, and a base side wall. A coupling assembly includes a lower coupling plate in the closed base top. The coupling assembly includes an upper coupling plate in the closed cup bottom. The L-shaped projections in the upper coupling plate are adapted to be inserted into apertures in the lower coupling plate for coupling the cup and the base. A sound assembly includes a lowermost sound plate in the closed base bottom. A musical chip is mounted to the lowermost sound plate. A button extending through the base side wall is operatively coupled to the musical chip.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including such equivalent constructions insofar as they do not depart from the spirit and scope of the present invention.

It is therefore an object of the present invention to provide a new and improved educational cup system which has all of the advantages of the prior art tooth brushing timing devices of known designs and configurations and none of the disadvantages.

It is another object of the present invention to provide a new and improved educational cup system which may be easily and efficiently manufactured and marketed.

It is further object of the present invention to provide a new and improved educational cup system which is of durable and reliable constructions.

An even further object of the present invention is to provide a new and improved educational cup system which is susceptible of a low cost of manufacture with regard to both materials and labor, and which accordingly is then susceptible of low prices of sale to the consuming public, thereby making such educational cup system economically available to the buying public.

Lastly, it is an object of the present invention to provide a new and improved educational cup system for playing a song for a programmable time corresponding to a preferred time for a child to brush his/her teeth, the playing of the song and the programming of the preferred time being done in a safe, simple, convenient, and economical manner.

These together with other objects of the invention, along with the various features of novelty which characterize the invention, are pointed out with particularity in the claims annexed to and forming a part of this disclosure.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front elevational view of an educational cup system constructed in accordance with the principles of the present invention.

FIG. 2 is a plan view of the system taken along line 2-2 of FIG. 1.

FIG. 3 is a bottom view of the system taken along line 3-3 of FIG. 1.

FIG. 4 is an exploded front elevational view of the educational cup system of the prior Figures.

FIG. 5 is a bottom view of the system taken along line 5-5 of FIG. 4.

FIG. 6 is a plan view of the system taken along line 6-6 of FIG. 4.

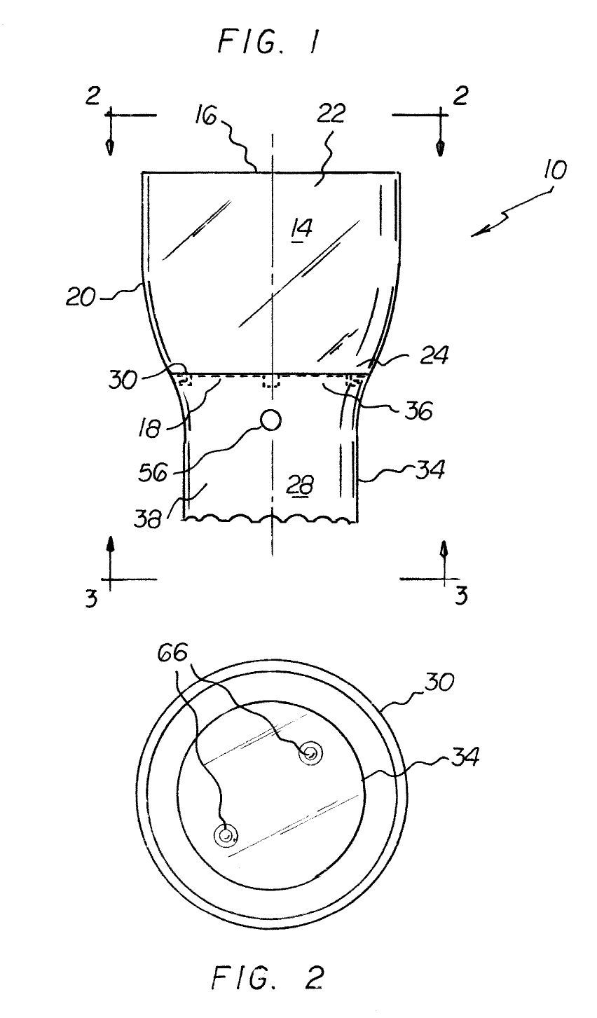

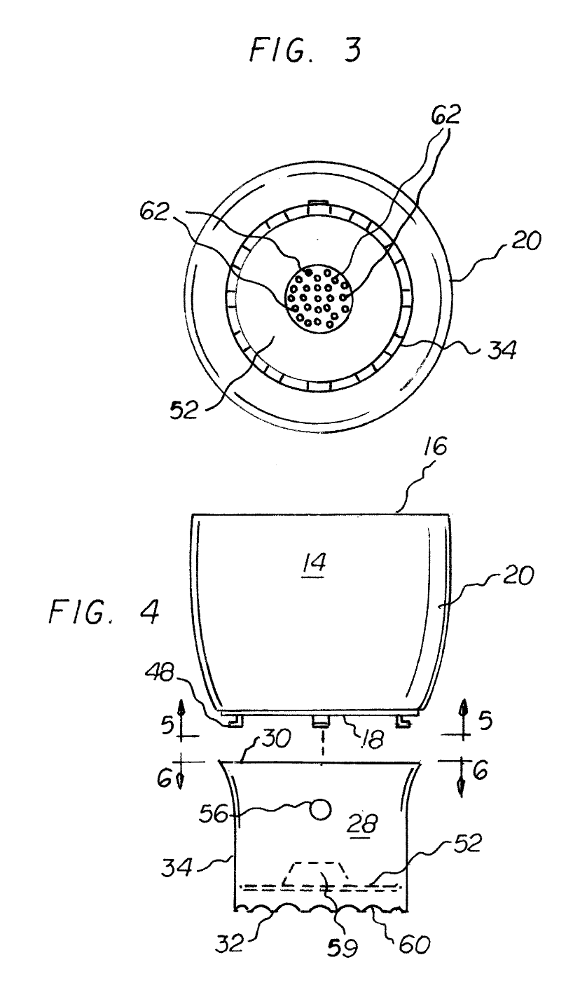

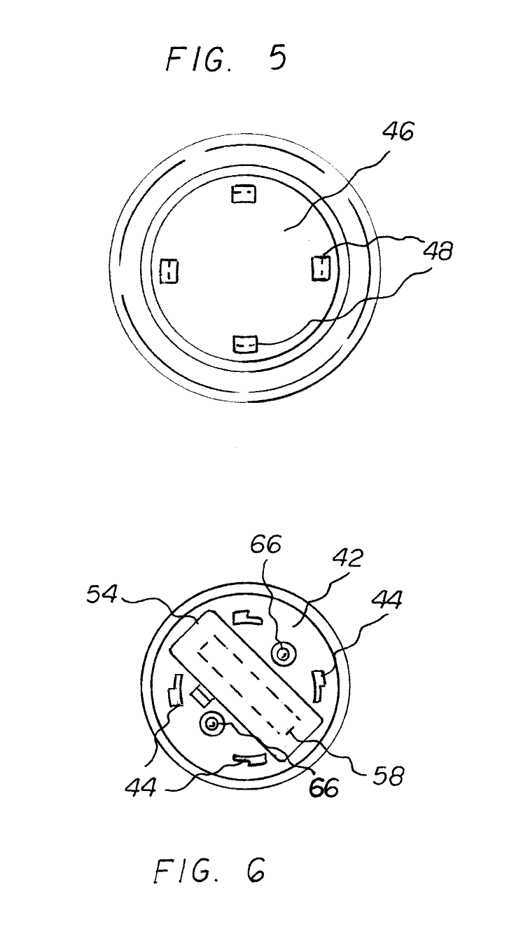

The same reference numerals refer to the same parts throughout the various Figures.

### DESCRIPTION OF THE PREFERRED EMBODIMENT

With reference now to the drawings, and in particular to FIG. 1 thereof, the preferred embodiment of the educational cup system embodying the principles and concepts of the present invention and generally designated by the reference numeral 10 will be described.

The present invention, the educational cup system 10 is comprised of a plurality of components. Such components in their broadest context include a cup, a base, a coupling assembly, and a sound assembly. Such components are individually configured and correlated with respect to each other so as to attain the desired objective.

From a specific viewpoint, in the preferred embodiment of the educational cup system of the present invention, first provided is a cup 14. The cup has an open cup top 16. The cup has a closed cup bottom 18. The cup further has side wall 20. The open cup top is spaced from the closed cup bottom by a cup height of 4.25 inches. The open cup top has a first cup diameter of 3.0 inches. The closed cup bottom has a second cup diameter of 2.5 inches. The second cup diameter is between 60 percent and 85 percent of the first cup diameter. The cup side wall has an upper cup section 22. The cup side wall has a lower cup section 24. The upper cup section has an upper cup section height of between 40 and 60 percent of the cup height. The upper cup section is cylindrical in configuration. The lower cup section has a lower cup section height of between 40 and 60 percent of the cup height. The upper cup section is convex in configuration. The cup is fabricated of plastic.

A base 28 is provided. The base has a closed base top 30. The base has a closed base bottom 32. The base has a base side wall 34. The closed base top is spaced from the closed base bottom by a base height of 2.0 inches. The closed base top has a first base diameter of 2.5 inches. The closed base bottom has a second base diameter of 2.0 inches. The second base diameter is between 75 percent and 85 percent of the first base diameter. The base side wall has an upper base section 36. The base side wall has a lower base section 38. The lower base section has a lower base section height of between 70 and 90 percent of the base height. The lower base section is cylindrical in configuration. The upper base section is concave in configuration. The closed bottom of the cup has a same diameter as the closed top of the base. The base is fabricated of plastic.

Further provided is a coupling assembly. The coupling assembly includes a circular lower coupling plate 42. The coupling plate is provided in the closed top of the lower section. The circular lower coupling plate has four apertures 44. The four apertures are similarly configured. The four apertures are equally spaced from the base side wall. The four apertures are radially and equally spaced from each other circumferentially. The coupling assembly includes a circular upper coupling plate 46. The circulate upper coupling plate is provided in the closed bottom of the upper section. The circular upper coupling plate has four L-shaped projections 48. The L-shaped projects are similarly configured. The L-shaped projections extend downwardly. The L-shaped projections are equally spaced from the base side wall radially. The L-shaped projections are equally spaced from each other circumferentially. The L-shaped projections are adapted to be inserted into the four apertures. In this manner twisting the cup with respect to the base in a first direction couples the cup and the base. The L-shaped projections are adapted to be removed from the four apertures by twisting the cup with respect to the base in a second direction. In this manner the cup and the base are axially separated.

Next provided is a sound assembly. The sound assembly includes a circular lowermost sound plate 59. The circulate lowermost sound plate is provided in the closed bottom of the base. The sound assembly includes a digital musical chip 54. The digital musical chip is mounted to the circular lowermost sound plate. An operator controlled button 56 is provided. The operator controlled button extends through the base side wall. The operator controlled button is operatively coupled to the digital musical chip. In this manner a single depressing of the button initiates the playing of a song for a preselected duration. Further in this manner depressing of the button multiple times initiates the playing of a song for a multiple number of preselected durations. The sound assembly also includes a battery 58 with a battery cover 54. The battery powers the digital musical chip and the button. The sound assembly also includes a plurality of holes 62. The holes are provided in the lowermost sound plate. The sound assembly also includes a plurality of semi-circular notches 60. The semi-circular notches are provided in the base side wall beneath the lowermost sound plate. In this manner disseminating the music from the digital musical chip is facilitated. Such components are individually configured and correlated with respect to each other so as to attain the desired objective.

Lastly, a plurality of multicolored light emitting diodes 66 are provided. The multicolored light emitting diodes are recessed in the closed base top. The plurality of multicolored light emitting diodes are operably coupled to the digital musical chip for illumination whenever music is being disseminated by the digital musical chip.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. An educational cup system comprising:
a cup having an open cup top and a closed cup bottom and a cup side wall;
a base having a closed base top and a closed base bottom and a base side wall;
a coupling assembly including a lower coupling plate in the closed base top, the lower coupling plate having apertures, the coupling assembly including an upper coupling plate in the closed cup bottom, the upper coupling plate having L-shaped projections, the L-shaped projections adapted to be inserted into the apertures for coupling the cup and the base; and
a sound assembly including a lowermost sound plate in the closed base bottom, a musical chip mounted to the lowermost sound plate, a button extending through the base side wall, the button operatively coupled to the musical chip.

2. The system as set forth in claim 1 wherein a single depressing of the button will initiate the playing of a song for a preselected time, and whereby a depressing of the button multiple times will initiate the playing of the song for a multiple number of preselected times.

3. The system as set forth in claim 1 wherein the cup has an upper cup section formed in a cylindrical configuration and a lower cup section in a convex configuration, and wherein the base has a lower base section formed in a cylindrical configuration and an upper base section in a concave configuration.

4. An educational cup system (10) for playing a song for a programmable time corresponding a preferred time for a child to brush his/her teeth, the playing of the song and the programming of the preferred time being done in a safe, simple, convenient, and economical manner, the system comprising, in combination:
a cup (14) having an open cup top (16) and a closed cup bottom (18) and a cup side wall (20), the open cup top being spaced from the closed cup bottom by a cup height of 4.25 inches, the open cup top having a first cup diameter of 3.0 inches, the closed cup bottom having a second cup diameter of 2.5 inches, the second cup diameter being between 60 percent and 85 percent of the first cup diameter, the cup side wall having an upper cup section (22) and a lower cup section (24), the upper cup section having an upper cup section height of between 40 and 60 percent of the cup height, the upper cup section formed in a cylindrical configuration, the lower cup section having a lower cup section height of between 40 and 60 percent of the cup height, the upper cup section having a convex configuration, the cup being fabricated of plastic;
a base (28) having a closed base top (30) and a closed base bottom (32) and a base side wall (34), the closed base top being spaced from the closed base bottom by a base height of 2.0 inches, the closed base top having a first base diameter of 2.5 inches, the closed base bottom having a second base diameter of 2.0 inches, the second base diameter being between 75 percent and 85 percent of the first base diameter, the base side wall having an upper base section (36) and a lower base section (38), the lower base section having a lower base section height of between 70 and 90 percent of the base height, the lower base section having a cylindrical configuration, the upper base section having a concave configuration, the closed bottom of the cup having a same diameter as the closed top of the base, the base being fabricated of plastic;
a coupling assembly including a circular lower coupling plate (42) in the closed top of the lower section, the circular lower coupling plate having four apertures (44) similarly configured and equally spaced from the base side wall radially and equally spaced from each other circumferentially, the coupling assembly including a circular upper coupling plate (46) in the closed bottom of the upper section, the circular upper coupling plate having four L-shaped projections (48) similarly configured and extending downwardly, equally spaced from the base side wall radially and equally spaced from each other circumferentially, the four L-shaped projections adapted to be inserted into the four apertures where upon twisting the cup with respect to the base in a first direction will couple the cup and the base, the four L-shaped projections adapted to be removed from the four apertures by twisting the cup with respect to the base in a second direction and axially separating the cup and the base;
a sound assembly including a circular lowermost sound plate (52) in the closed bottom of the base, a digital musical chip (59) mounted to the circular lowermost sound plate, an operator controlled button (56) extending through the base side wall, the operator controlled button operatively coupled to the digital musical chip whereby a single depressing of the button will initiate the playing of a song for a preselected duration, and whereby a depressing of the button multiple times will initiate the playing of a song for a multiple number of preselected durations, a battery (58) powering the digital musical chip and the button, the battery having a battery cover (54), the sound assembly including a plurality of holes (62) in the lowermost sound plate, the sound assembly also including a plurality of semi-circular notches (60) in the base side wall beneath the lowermost sound plate to facilitate disseminating the music from the digital musical chip; and
a plurality of multicolored light emitting diodes (66) recessed in the closed base top, the plurality of multicolored light emitting diodes being operatively coupled to the digital musical chip for illumination whenever music is being disseminated by the digital musical chip.
